(19) United States
(12) Patent Application Publication
(10) Pub. No.: US 2005/0149409 A1
(43) Pub. Date: Jul. 7, 2005

(54) Method of producing customer-designed jewerly utilizing services of foundry

(76) Inventor: Jay Whaley, San Diego, CA (US)

Correspondence Address: Eric Hanscom;Suite 204, 6994 El Camino Real, Carlsbad, CA, 92009, US

(21) Appl. No.: 10/751,318

(22) Filed: Jan. 3, 2004

(51) Int. Cl. G06F 17/60

(52) U.S. Cl. 705/26

(57) ABSTRACT

The invention is directed toward a business method by which a retailer can sell to a customer the tools, materials, and instruction necessary for the customer to create a wax replica of a desired piece of jewelry, which is then returned to the retailer. The retailer then sends the wax replica to a commercial foundry, which makes a mold of the wax replica and after melting away the wax, pours molten metal into the mold, creating a metal piece of jewelry identical to that designed by the customer. The commercial foundry then performs finishing work on the jewelry and returns it to retailer, who may also perform finishing and gem-setting work before returning the finished jewelry product to the customer.

### BACKGROUND OF THE INVENTION

Jewelry manufacture is an ancient art which dates back to the necklaces Stone Age humans made from teeth and bones. The first records of the use of silver and gold in jewelry making was in Egypt, dating back over 3,000 years. Somewhere in between the early Stone Age “do-it-yourself” necklaces and the elegant jewelry of the Egyptians, the occupation of a professional jewelry maker evolved. Today, jewelry manufacture is much more diverse and advanced than in ancient times, combining old and new technologies and craftsmanship in creative new ways. Jewelry manufacturing is now big business, with jewelry shops appearing in shopping malls throughout the world, jewelers advertising on major TV stations, and the act of giving gifts of jewelry ingrained into our culture as a way of recognizing the importance of certain events or as a way of showing affection or gratitude.

The prior art contains a number of jewelry-related patents directed mainly with gem-mounting inventions. U.S. Pat. No. 645,909 teaches a jewelry mounting means which used vibration to enhance the appearance of precious metals.

Another early jewelry-related patent, U.S. Pat. No. 922,212 taught a jewelry-mounting technique whereby a gem could be pivoted in its setting so that in one iteration the gem was fully visible; in the other is was nearly undetectable. Another patent dealing with gem movement was U.S. Pat. No. 4,294,084, which taught a method by which the gem can be moved to enhance its reflective exposure. The prior art does not, however, teach any methods by which a jeweler can make his or her own jewelry in a method such as that taught by this invention.

As jewelry making has become more and more commercialized over the centuries, there has remained a large number of individuals who, for a variety of reasons, wish to make their own jewelry. For some, the cost of commercial jewelry may seem unreasonably high; others cannot find anything commercially manufactured with suits their precise needs, thus they must make it themselves; still others enjoy it as a hobby or semi-commercial sideline to a regular job. In any case, there remains today a large number of people who desire to make their own jewelry, and yet lack the resources or are not willing to spend the money to acquire the foundry, which is the main machine needed to make cast-metal jewelry.

To make a ring or other article of metal jewelry, (ring making is the best mode of this invention and shall be used as the example herein) the main method involves creating a wax model of the ring, casting the wax model in between two plaster of Paris molds, then, after molds “set” or dry, heating them to the point where the wax melts away, leaving and empty cavity in the molds the exact shape of the desired ring. The desire type of metal is then melted in a foundry, and poured into the mold, where it is allowed to cool. After reaching room temperature, the mold is then opened, the rough ring is removed, and any burrs or other irregularities are buffed out or otherwise removed. Once this is done, any stones or diamonds are set into the ring and it is ready for sale, gift, or use by the jewelry maker.

Commercial jewelry manufacturing enterprises usually have foundries and mold-making facilities on-site, so that they can efficiently produce large quantities of jewelry. The smaller operations, and the “do-it-yourselfers”, to whom this invention is particularly directed, frequently will not invest in theses machines, hence a need exists for a method by which a jewelry maker without molding facilities and a foundry can design his or her own jewelry, and have it produced by an outside source.

There are a number of methods which can be used to create jewelry out of precious metals. The first method, which is broadly called “fabrication”, involves working directly in the metal itself. This involves an assortment of hand tools and power equipment to cut, bend, file, and polish the sheet and wire forms which are made into finished jewelry. Torches are also used to soften the metal, and to solder different elements of the jewelry together. A well equipped shop is necessary to provide all the tools and equipment to fabricate jewelry.

Casting is another method used to create precious metal jewelry. In that method, a wax model is created which is an exact replica of the finished piece desired. The wax model then has one or more wax sprues (or vents, which connect the model to the outside of the mold, and later becomes the passageway for the cast metal) attached to it, and the model is “invested” or covered with liquid mold material (a dental-type metal casting investment, similar to “plaster of Paris”) and allowed to dry. When this mold has cured, it is then put into an oven and slowly heated up to 1300 degrees F., to totally eliminate the wax model from the mold. When this is accomplished, a centrifuge or vacuum-type casting machine is used to drive melted liquid metal into this cavity which was formerly the wax model, which duplicates the wax model in every detail. The investment mold, after casting, is allowed to cool slightly, then plunged into water which dissolves the investment material and frees the new casting. The sprue is then cut off the casting, the oxidation of casting removed in warm acid, and the cast object (originally wax) is filed, sanded, and polished into it's finished form, and can be set with gemstones, if designed with that intention.

For a person desiring to make jewelry themselves, and control everything themselves, a very expensive array of hand tools and equipment would be needed to fabricate or cast jewelry. An appropriate studio would also be required in which noisy operations could be carried out, as well as torch flames and potentially smelly techniques integral to jewelry production.

A person wanting to produce cast jewelry, who was not particularly interested in assembling the required equipment or the labor to produce the jewelry from start to finish, could consider only being involved in the creation of the wax model—the creative aspect of the jewelry process. If the wax designer/creator could just create the wax model, which requires minimal hand tools and studio requirements, and turn over the casting and finishing processes to manufacturing professionals with the casting and finishing equipment and expertise, he/she could then only worry about the wax model creation, and have others do the rest.

This unique business model offers to sell the customer the correct hand tools, waxes, and expertise for them to create their own wax models, and a service which offers to take the finished wax model, mail it back to the tool supplier in a crush-proof self-addressed mailer, and have the wax cast in the metal of their choice, polished, and mailed back to them in it's finished form.

This service can only be offered and achieved by someone with overall knowledge of the model-making and casting business, who can not only supply the right tools and materials, but can coordinate the manufacture of the finished product, and return a quality product to the consumer.

When a wax model is received by the manufacturing facility, it is analyzed to determine the correct spots in which to attach the wax sprues, which will serve to evacuate the melted wax out of the investment mold in the burn-out oven, and the passage for the molten metal to fill the mold cavity during the casting process. At this time, weight of the wax model with its attached wax sprues is made to ascertain the weight of metal needed to fill the mold cavity and sprues. The specific gravity of the wax model as well as the metal with which it will be cast can accurately determine the finished weight of the jewelry item cast, and this information, as well as estimated finish work required can be transmitted to the retailer to establish firm manufacturing costs. These casting, finishing, stone setting as well as gemstone costs can be known before the casting process is begun, and this cost can be given to the customer before work is started, so that the customer is aware of any and all charges before work is begun. If the customer wants to duplicate the finished piece, he/she can have a rubber mold made, which is used to recreate a duplicate wax model, which is then cast and finished like the original. A price is charged to the customer for the mold, which is returned to the customer with the original piece and any copies.

After the wax model is sprued by the caster, it is invested, which means the liquid “plaster” is poured into the flask which contains the wax model with its sprues, it is vacuumed to pull any bubbles out of the investment, and left to dry for at least ½ hours before putting in the burn-out oven. The oven temperature cycle is closely controlled to slowly bring up the temperature of the casting flask (with wax model inside) to a maximum of 1350 degrees F. to vaporize any wax, which usually takes about 8 hours. Casting temperature is lowered to about 900 degrees F., and the casting whether by centrifuge or vacuum system, is done at this temperature, to allow the melted metal to fill the mold cavity precisely and not “chill” before filling completely. After casting the flask, it is allowed to cool slightly, and plunged into water to dissolve off the investment. An ultra-sonic cleaner is used to vibrate off the investment from the model, and a steamer, which uses a stream of 80 lbs of steam pressure to blast the investment off the casting is also used. When all investment is removed, the cast object is “pickled” in a mild acid to remove surface oxidations formed by the casting process, and the sprues are cut off, filed, sanded back to the original shape, and the piece is then fine sanded, sometimes tumbled with abrasive media in larger manufacturing companies, and hand polished with high-speed buffing machines to produce polished surfaces, if required. A Stone Sefter is sometimes employed to set gemstones in the finished piece if it is designed with that purpose, and a final polishing is required after the setter is finished. An ultrasonic cleaner and stem is used to remove any traces of polish, and the finished piece is wrapped in a small piece of “watch paper” and given or shipped to the consumer.

The current invention solves the problem faced by many do-it-yourself jewelry makers and small jewelry operations which do not have all the aforementioned machinery by providing an inexpensive and efficient method by which an individual can purchase the tools, materials, and informational literature necessary to create a wax replica of the desired jewelry, have the replica shipped to a commercial jewelry manufacturing facility, have it made, have any gemstones affixed or additional work done.

### BRIEF SUMMARY OF INVENTION

The present invention relates to a method of allowing a jewelry maker to have custom-designed jewelry he or she designed be manufactured by a commercial foundry. More particularly, the present invention teaches a method by which a jewelry maker (the “customer”) can purchase a set of jewelry making tools, materials, and instructions from an internet site, retail shop, or school jewelry-making program (the “retailer”), make a wax carving or replica of the desired finished piece of jewelry, return the wax replica to the retailer, who then sends it to a commercial foundry and mold-making facility (the “foundry”), which makes a mold of the wax replica in Plaster of Paris or other mold-making material. Once the mold has dried, or “set”, the wax replica is heated above its melting point and the was melts away, leaving a cavity in the mold which is the exact shape of the desired jewelry. The foundry then heats up the desired metal, and pours it into the cavity in the mold. When the metal cools down to room temperature and hardens from liquid state into solid state, the mold is removed and the jewelry is taken out and inspected for burrs or other imperfections, which are then buffed out or removed in other manners. The finished jewelry is then transported back to the retailer, who returns it to the customer.

Further objects and features of this invention will be apparent to one skilled in the art.

### BRIEF DESCRIPTION OF THE DRAWINGS

FIG. 1 is schematic view of the method by which a jewelry maker can get the tools, materials, and instructional information from a retailer needed to make a wax carving or replica of a desired piece of jewelry from a retailer, create the replica, have the replica shipped to a foundry via the retailer, where the replica is turned into a finished piece of jewelry, and shipped back to the retailer, who, in turn, gives it to the customer.

### DETAILED DESCRIPTION OF THE INVENTION

The invention is directed toward a business method by which a retailer can sell to a customer the tools, materials, and instruction necessary for the customer to create a wax replica of a desired piece of jewelry, which is then returned to the retailer. The retailer then sends the wax replica to a commercial foundry, which makes a mold of the wax replica and after melting away the wax, pours molten metal into the mold, creating a metal piece of jewelry identical to that designed by the customer. The commercial foundry then performs finishing work on the jewelry and returns it to retailer, who may also perform finishing and gem-setting work before returning the finished jewelry product to the customer.

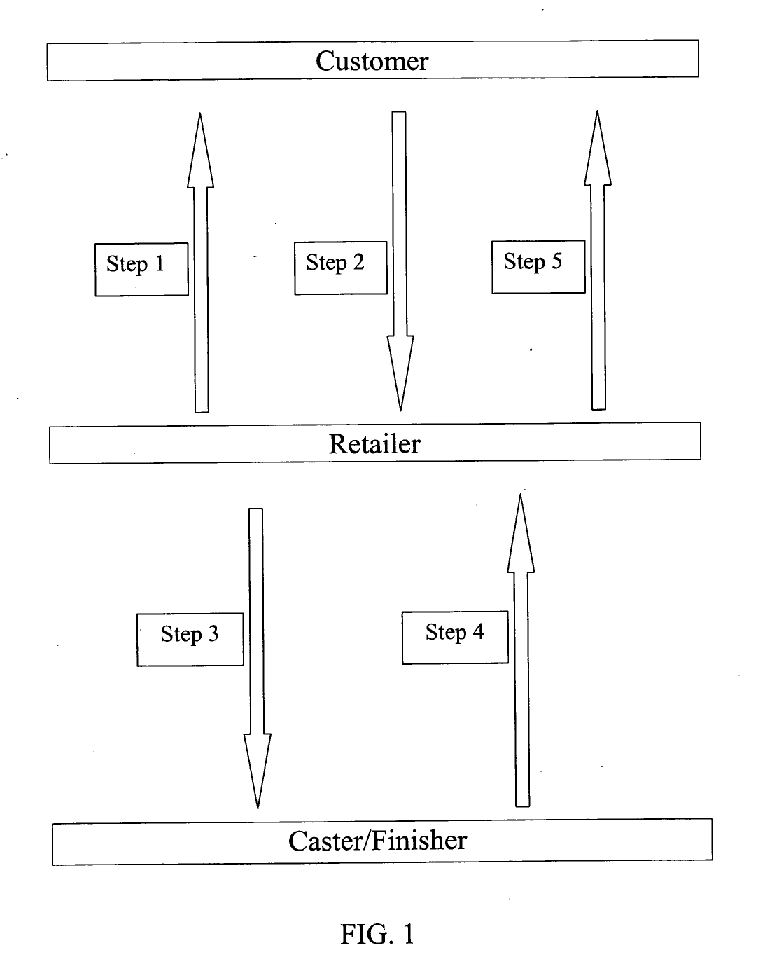

Referring to FIG. 1, Step 1, a customer can order the correct hand tools, waxes, and expertise for them to create their own wax models. In Step 2, after he/she has finished creating the wax model, the customer mails it back to the retailer in a crush-proof self-addressed mailer, provided as part of the customer's initial order by the retailer. In Step 3, the retailer forwards the wax model to a foundry, where wax is cast in the metal of the customer's choice, polished, and mailed back to the retailer in Step 4. The retailer may do additional work, or, if the jewelry is already in its finished form, just mail the jewelry back to the customer in Step 5.

1. A method of allowing a jewelry maker without mold-making or foundry facilities to make a ring or other item of precious or semi-precious metal, comprising the following steps:
A retail shop, internet retail site, college jewelry-making class, or other company, individual or location (the “Retailer”) which provides to a jewelry maker (the “Customer”) the tools, supplies, and instruction, either in the form of classroom instruction or written instructional manuals, sufficient to allow the jewelry maker to produce a wax carving, or replica of a desired piece of jewelry; and
The means by which the Customer can return the wax replica to the Retailer, such means including but not limited to protective boxes addressed to the Retailer, postage paid or unpaid; and
The means by which the Retailer can send the wax replica to a commercial jewelry manufacturing facility or foundry (the “Foundry”), at which a mold can be made of the wax replica, said mold being made of plaster of Paris or similar material which is soft and malleable when wet, such that it can be pushed to completely encase the wax replica, but which dries to a hardened solid form as its liquid component evaporates; and
The means by which the Foundry can heat the wax replica within the mold above the melting point of the wax, such that the wax melts away, leaving a cavity within the mold in the shape of the desired piece of jewelry; and
The means by which the Foundry can heat precious or semi-precious metals beyond their melting point, such that molten metal can be poured into the mold, and, when cooled, create a metal pieces of jewelry in the exact shape and dimensions as that initially carved as a wax replica by the Customer; and
The means by which the Foundry can correct any burrs or other imperfections in the jewelry piece through buffing or other means of smoothing; and
The means by with the Foundry can affix gemstones and/or perform additional work that can be done to further enhance the jewelry; and
The means by which the Foundry can transport the metal jewelry piece back to the Retailer, such as but not limited to protective boxes addressed to the Retailer, both pre-paid and non pre-paid postage; and
The means by which a Retailer can also affix gemstones and/or perform additional work that can be done to further enhance the jewelry before returning it to the Customer; and
The means by which the Retailer can return the finished piece of metal jewelry to the Customer, including but not limited to protective boxes addressed to the Customer.
